(19) United States
(12) Patent Application Publication
(10) Pub. No.: US 2013/0304779 A1
(43) Pub. Date: Nov. 14, 2013

(54) METHOD AND DEVICE FOR GENERATING BIG PRIME

(71) Applicants: Zhou Lu, Beijing (CN); Huazhang Yu, Beijing (CN)

(72) Inventors: Zhou Lu, Beijing (CN); Huazhang Yu, Beijing (CN)

(73) Assignee: Feitian Technologies Co., Ltd., Beijing (CN)

(21) Appl. No.: 13/976,512

(22) PCT Filed: Aug. 29, 2012
(86) PCT No.: PCT/CN2012/080710

§ 371 Date: Jun. 27, 2013

(30) Foreign Application Priority Data
Sep. 26, 2011 (CN) 201110289038.1

(51) Int. Cl. G06F 7/58

(52) U.S. Cl. CPC G06F 7/58
USPC 708/250

(57) ABSTRACT

The invention discloses a method for generating a large prime number and a system thereof. The method includes Step 1, generating a random number in size corresponding to number of digits input by a user, in which number of digits of the random number is identical to number of digits input by the user; Step 2, obtaining remainders by dividing all prime numbers in a predetermined little prime number table by a current value of the random number so as to form a remainder array; Step 3, determining whether there is a remainder 0 in the remainder array, if yes, going to Step 4; otherwise, going to Step 5; Step 4, updating the random number with a predetermined step, updating remainders in remainder array and going to Step 3; Step 5, checking for whether a current value of the random number is a prime number, if yes, going to Step 6; otherwise, going to Step 4; and Step 6, storing or outputting the current value of the random number. The solution provided by embodiments of the invention reduces primality test times, and thus saves time of generating a large prime number.

### TECHNICAL FIELD

The invention relates to cryptography field, and particularly relates to method for generating a large prime number and device thereof.

### PRIOR ART

When constructing a password, especially when constructing a public key or a public password, an embedded system is required to generate a large prime number which is used in encryption, etc. For example, key parameters used in RSA encryption needs to use the large prime number generated by an embedded system.

In the prior art, generating a large prime number includes generating a random number with enough length; determining whether the random number is a prime number, if the random number is not a prime number, re-generating a group of new random numbers or modifying the current random number to some extent and determining whether the new random number is a prime number again till a random number which meets the requirement is generated.

In process of generating a large prime number, the inventor finds at least the following shortcomings: the primality test method widely used currently takes longer time, and in most cases, a large prime number can only be obtained by searching for hundreds, even thousands of random numbers, viz., hundreds or thousands of primality test needs to be used for obtaining a large prime number, and thus generating a large prime number takes longer time.

### SUMMARY OF THE INVENTION

Embodiments of the invention provide a method for generating a large prime number and a device thereof, which saves time for generating a large prime number.

According to one aspect of the present invention, there is provided a method for generating a large prime number, characterized in that said method comprises

Step 1, generating a random number in size corresponding to number of digits input by a user, in which the number of digits of the random number is identical to the number of digits input by the user;

Step 2, obtaining remainders by dividing all prime numbers in a predetermined little prime number table by a current value of the random number respectively, so as to form a remainder array;

Step 3, determining whether any remainder is 0 in the remainder array, if yes, going to Step 4; otherwise going to Step 5;

Step 4, updating the random number according to a predetermined step size, updating all remainders in the remainder array, and returning to Step 3;

Step 5, checking for whether the current value of the random number is a prime number, if yes, going to Step 6; otherwise, going to Step 4; and

Step 6, storing or outputting the current value of the random number.

According to another aspect of the present invention, there is provided a method for generating a large prime number, characterized in that said method comprises

Step 1, generating a random number according to the number of digits input by a user, in which the number of digits of the random number is identical to the number of digits input by the user;

Step 2, obtaining remainders by dividing prime numbers in a predetermined little prime number table by a current value of the random number, so as to form a remainder array;

Step 3, determining whether any remainder is 0 in the remainder array, if yes, going to Step 4; otherwise, going to Step 7;

Step 4, updating remainders in the remainder array with a predetermined step size one by one; or updating remainders in the remainder array with the step size and prime numbers in the little prime number table one by one;

Step 5, determining whether any remainder is 0 in the remainder array, if yes, going to Step 4; otherwise, going Step 6;

Step 6, updating the random number;

Step 7, checking for whether the current value of the random number is a prime number, if yes, going to Step 8, otherwise, going to Step 4; and

Step 8, storing or outputting the current value of the random number.

The solution provided by the embodiments of the invention select generated random numbers by modulo operation and performing primality test on the random numbers which meet the requirement, and thus reduces times for primality test and further saves time for generating a large prime number. The solution solves a problem of longer time spending on generating a large prime number by too many times of primality test.

### DRAWINGS OF THE INVENTION

For clarifying embodiments of the invention or solutions in the prior art, a brief description of the drawings for explaining the embodiments or the prior art will be given as below. Obviously, the described drawings are just part of the embodiments of the invention, and other drawings can be obtained according to the drawings by one ordinary skill in the art without involving in an inventive step.

FIG. 1 illustrates a flow chart of a method for generating a large prime number provided by Embodiment 1 of the invention;

FIG. 2 illustrates a flow chart of a method for generating a large prime number provided by Embodiment 2 of the invention;

FIG. 3 illustrates a flow chart of a method for generating a large prime number provided by Embodiment 3 of the invention;

FIG. 4 illustrates a flow chart of a method for generating a large prime number provided by Embodiment 4 of the invention;

FIG. 5 illustrates a flow chart of a method for generating a large prime number provided by Embodiment 5 of the invention;

FIG. 6 illustrates a flow chart of a method for generating a large prime number provided by Embodiment 6 of the invention;

FIG. 7 illustrates a flow chart of a method for generating a large prime number provided by Embodiment 7 of the invention;

FIG. 8 illustrates a structural diagram of a device of generating a large prime number provided by Embodiment 8 of the invention; and

FIG. 9 illustrates a structural diagram of a device of generating a large prime number provided by Embodiment 9 of the invention.

### EMBODIMENTS OF THE INVENTION

Solution of embodiments of the invention will be detailed in accompanying with the drawings of the invention. Obviously, the embodiments set forth are just part embodiments, not all embodiments. All other embodiments accomplished by a skill technician in the art without involving in an inventive effort based on embodiments of the invention will fall below the scope of protection of the invention.

### Embodiment 1

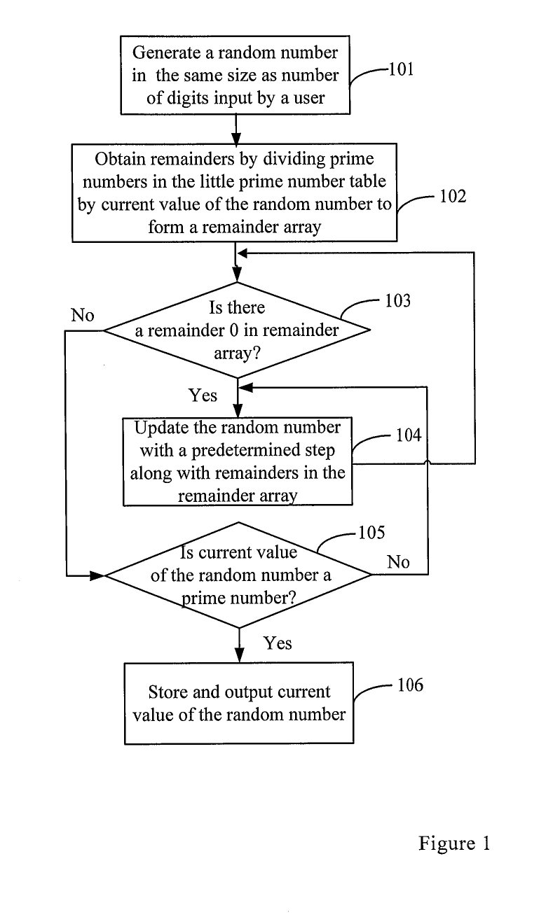

As illustrated in FIG. 1, a flow chart of a method for generating a large prime number is provided in Embodiment 1 of the invention, including steps as follows.

Step 101, generate a random number in size corresponding to number of digits input by a user.

Specifically, in Step 101 of the Embodiment 1, the number of digits of the random number is identical to the number of digits input by the user. In order to ensure the generated random number with enough length, the highest order bit of the random number is set to be 1; and in order to ensure that the generated random number is an odd number, so as to narrow scope of the random number and ease to generate the random number, the lowest order bit of the random number is set to be 1; and in order to generate the prime number easily, the random number can be set with other methods and details of the methods are omitted herein.

Step 102, divide all prime numbers in a little prime number table by a current value of the random number respectively, so as to form a remainder array.

The remainder array includes all remainders obtained by dividing prime numbers by the random number respectively. In the Embodiment 1, dividing prime numbers in the little prime number table by the current random number respectively in Step 102 may be dividing all prime numbers within a predetermined value range in the little prime number table by the current random number respectively; or may divide those prime numbers smaller than the current random number in the little prime number table by the current random number; or maybe dividing those prime numbers within a value range smaller than the current random number by the current random number respectively, and details of it are eliminated.

In the Embodiment 1, the random number can be stored in the form of word set including at least one word, and words in the word set are arranged from high order bit to low order bit.

Obtaining a remainder by dividing one of the prime numbers in the little prime number table by a current value of the random number includes:

A. dividing the prime number obtained from the little prime number table by a current word of the random number starting from the highest byte, so as to obtain a current remainder;

B. determining whether the current word is a word of the lowest byte, if yes, going to Step C; otherwise, going to Step D;

C, ascertaining the current remainder as a remainder obtained by dividing the prime number by the random number;

D. concatenating the current remainder with a next word of the random number, so as to obtain an intermediate value, in which the current remainder locates at high order digit of the intermediate value and the next word locates at low order digit of the intermediate value, and the next word is a low-order-digit word next to the current word in the random number; and

E. obtaining a new remainder by dividing the prime number by the intermediate value, replacing the current word with the next word and replacing the current remainder with the new remainder, returning to Step B.

In the above steps, the current word and the next word are two adjacent words in the word set of the random number and the current word is in a higher byte than the next word.

Because the random number is stored in the form of word set, if number of words stored in the random number is M, dividing all prime numbers in the little prime number table by the current value of the random number one by one in Step 102 maybe obtaining remainders by dividing all prime numbers in the little prime number table by the current value of the random number including M words with a double-word variable method, or maybe obtaining remainders by dividing all prime numbers in the little prime number table by current value of the random number including M words with other methods, and details of them are omitted.

Step 103, determine whether there is a remainder 0 in the remainder array, if yes, go to Step 104; otherwise, go to Step 105.

Step 104, update the random number according to a predetermined step, update the remainders in the remainder array and return to Step 103.

Specifically, updating all remainders in the remainder array maybe updating remainders in the remainder array respectively according to a predetermined step; maybe updating remainders in the remainder array according to the step and prime numbers in the little prime number table, which includes updating remainders in the remainder array respectively with the step and if one remainder updated is smaller than 0 and greater than or identical to a prime number corresponding to the remainder in the little prime number table, updating the remainder according to the prime number. Specifically, if the remainder is smaller than 0, adding a prime number corresponding to the remainder in the little prime number table to the remainder; if the remainder is greater than or identical to the prime number corresponding to the remainder in the little prime number table, subtracting the prime number corresponding to the remainder in the little prime number table from the remainder or replacing the remainder with a remainder obtained by dividing the prime number corresponding to the remainder in the little prime number table by the remainder.

Specifically, the updating the random number with a predetermined step includes adding the step (or called a step length, a step width, or a step size in the context and Claims) to the random number, and then updating the remainders in the remainder array with the step respectively by adding the step to each remainder in the remainder array.

The updating the random number with the step also includes subtracting the step from the random number, and then updating the remainders in the remainder array respectively with the step by subtracting the step from each remainder in the remainder array.

The predetermined step can be an even number which may be a positive number or a negative number.

Step 105, check for whether a current value of the random number is a prime number, if yes, go to Step 106; otherwise go to Step 104.

If the current value of the random number is P, the checking for whether the current value of the random number is a prime number in Step 105 includes obtaining remainders by dividing the current value of the random number by at least one random number which is smaller than the current value of the random number, to the (P-1)th power respectively, so as to form a first random remainder array, and checking for whether each remainder in the first random remainder array equals to 1; or obtaining remainders by dividing the current value of the random number by at least one random number which is smaller than the current value of the random number, to the Pth power respectively so as to form a second random remainder array and obtaining remainders by dividing the current value of the random number by at least one random number which is smaller than the current value of the random number respectively to form a third random remainder array, and checking for whether each remainder in the second random remainder array equals to the corresponding remainder in the third random remainder array; and other methods can be used for checking for whether the current value of the random number is a prime number, and details of it are omitted.

Step 106, store or output the current value of the random number. The solution provided by the Embodiment 1 of the invention selects generated random numbers by modulo operation and performing primality test on the random numbers which meet the requirement, and thus reduces times for primality test, and further saves time for generating a large prime number. The solution solves a problem of longer time spending on generating a large prime number by too many times of primality test.

### Embodiment 2

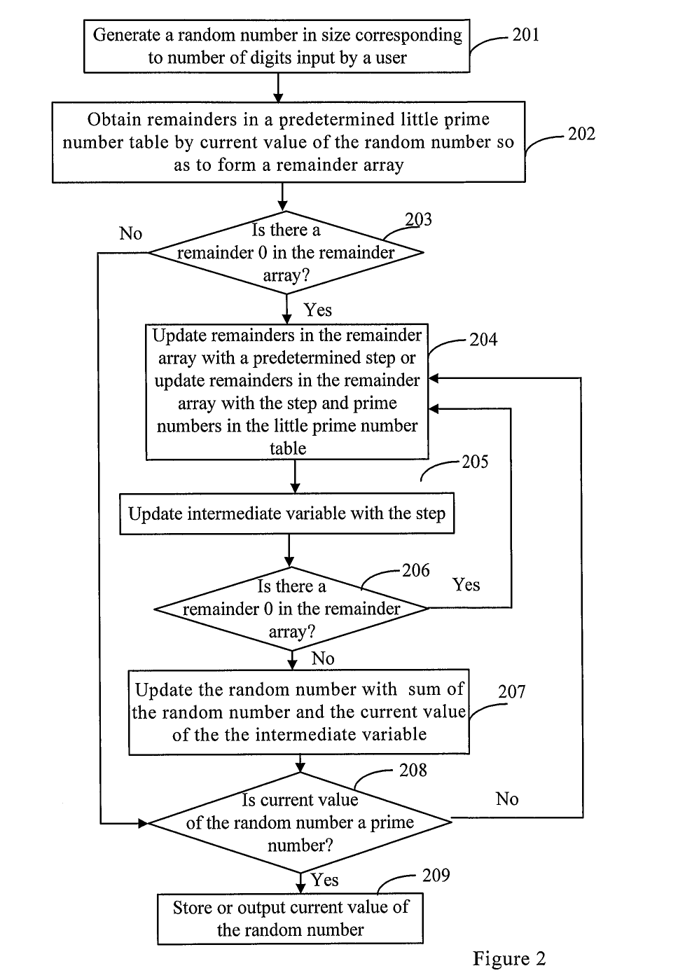

As illustrates in FIG. 2, a flow chart of a method for generating a large prime number provided by Embodiment 2 of the invention includes steps as follows.

Step 201, generate a random number in size corresponding to the digits input by a user.

Number of digits of the random number is identical to number of the digits input by the user. If the highest order bit of the random number generated is not 1, set the highest order bit of the random number to be 1; and if the lowest order bit of the random number generated is not 1, set the lowest order bit of the random number to be 1.

Step 202, obtain remainders by dividing all prime numbers in a predetermined little prime number table by a current value of the random number so as to form a remainder array.

Step 203, determine whether there is a remainder 0 in the remainder array, if yes, go to Step 204; otherwise, go to Step 208.

Step 204, update all remainders in the remainder array one by one according to a predetermined step or update all remainders in the remainder array one by one according to the step and prime numbers in the little prime number table.

Specifically, the updating remainders in the remainder array according to the step and prime numbers in the little prime number table one by one may include updating one remainder in the remainder array according to the step, which specifically is, if the remainder is smaller than 0, greater than or identical to a prime number corresponding to the remainder in the little prime number table, updating the remainder according to the prime number, viz. if the remainder is smaller than 0, adding the remainder to the prime number corresponding to the remainder in the little prime number table; if the remainder is greater than or identical to the prime number corresponding to the remainder in the little prime number table, subtracting the prime number corresponding to the remainder in the little prime number table from the remainder or updating the remainder with a remainder result by dividing the prime number corresponding to the remainder in the little prime number table by the remainder.

In the above step, updating each remainder in the remainder array according the step may be adding the step to each remainder in the remainder array, or subtracting the step from each remainder in the remainder array.

Step 205, update an intermediate variable according to the step.

Initial value of the intermediate variable is 0. If in Step 204 the step is added to remainders in the remainder array respectively, the updating an intermediate variable according to the step is adding the step to the intermediate variable. If in Step 204 the step is subtracted from remainders in the remainder array respectively, the updating an intermediate variable according to the step is subtracting the step from the intermediate variable. The step can be an even number.

It is noted that Step 205 can be executed before Step 204 or executed synchronously with Step 204.

Step 206, determine whether there is a remainder 0 in the remainder array, if yes, go to Step 204; otherwise go to Step 207.

Step 207, replace the random number with sum of the random number and current value of the intermediate variable.

Step 208, check for whether the current value of the random number is a prime number, if yes, go to Step 209; otherwise, go to Step 204.

Step 209, store or output the current value of the random number.

The solution provided by the Embodiment 2 of the invention selects generated random numbers by modulo operation and performing primality test on the random numbers which meet the requirement, and thus reduces times for primality test and further saves time for generating a large prime number. The solution solves a problem of longer time spending on generating a large prime number by too many times of primality test.

### Embodiment 3

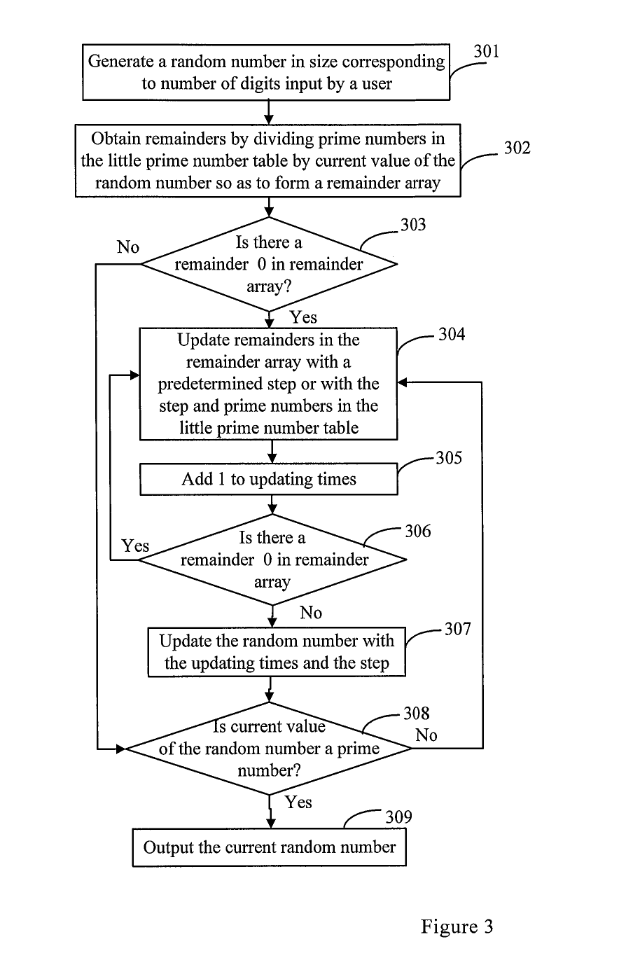

As illustrated in FIG. 3, a flow chart of a method for generating a large prime number is provided by Embodiment 3 of the invention, including the following steps.

Step 301, generate a random number with corresponding size according to digits input by a user.

Number of digits of the random number is identical to number of the digits input by the user. If the highest order bit of the random number generated is not 1, set the highest order bit of the random number to be 1; and if the lowest order bit of the random number generated is not 1, set the lowest order bit of the random number to be 1.

Step 302, obtain remainders by dividing all prime numbers in a predetermined little prime number table by a current value of the random number to form a remainder array.

Step 303, determine whether there is remainder 0 in the remainder array, if yes, go to Step 304; otherwise, go to Step 308.

Step 304, update all remainders in the remainder array by a predetermined step respectively, or update all remainders in the remainder array by a step and a prime number in the little prime number table.

Specifically, the updating the remainders in the remainder array according to the step and a prime number in the little prime number table respectively may include updating each remainder in the remainder array according to the step which specifically is: if the remainder is smaller than 0, greater than or identical to a prime number corresponding to the remainder in the little prime number table, replacing the remainder with the prime number, viz. if the remainder is smaller than 0, adding the remainder to the prime number corresponding to the remainder in the little prime number table; if the remainder is greater than or identical to the prime number corresponding to the remainder in the little prime number table, subtracting the prime number corresponding to the remainder in the little prime number table from the remainder or replacing the remainder with a remainder result by dividing the prime number corresponding to the remainder in the little prime number table by the remainder.

In the above step, updating each remainder in the remainder array according the step may be adding the step to each remainder in the remainder array, or be subtracting the step from each remainder in the remainder array.

Step 305, add 1 to updating times.

Initial value of the updating times is 0.

It is noted that Step 305 may be executed before Step 304, or be executed synchronously with Step 304.

Step 306, determine whether there is remainder 0 in the remainder array, if yes, go to Step 304, otherwise, go to Step 307.

Step 307, update the random number according to the updating times and the step.

Specifically, if in Step 304, the step is added to each remainder in the remainder array, the updating the random number according to the updating times and the step is adding a product of the updating times and the step to the random number. If in Step 304, the step is subtracted from each remainder in the remainder array, the updating the random number according to the updating times and the step is subtracting a product of the updating times and the step from the random number. The step can be an even number.

Step 308, check for whether the current value of the random number is a prime number, if yes, go to Step 309, otherwise, go to Step 304.

Step 309, store or output the current value of the random number.

The solution provided by the Embodiment 3 of the invention selects generated random numbers by modulo operation and performing primality test on the random numbers which meet the requirement, and thus reduces times for primality test and further saves time for generating a large prime number. The solution solves a problem of longer time spending on generating a large prime number by too many times of primality test.

### Embodiment 4

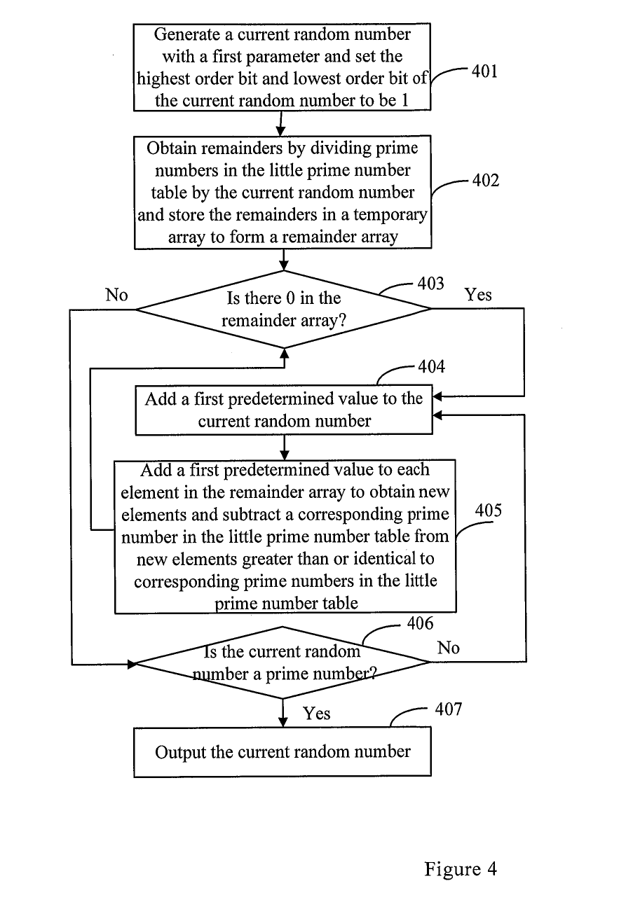

As illustrated in FIG. 4, a flow chart of a method for generating a large prime number is provided by Embodiment 4 of the invention, including the following solution.

Generate a random number with predetermined number of digits according to a first parameter being input, of which the first parameter is number of digits of the random number. Preferably, in Embodiment 4 of the present invention, a random number exceeding 4 bytes is defined as a large number. Perform little prime number sifting on the random number, and then perform primality test on the random number after the above sifting, if the primality test passes, take the random number as a large prime number and output the large prime number. Preferably, the little prime number table in Embodiment 4 of the invention is a set of prime numbers without exceeding 4 bytes and elements in the little prime number table are pre-stored in the computer. Embodiment 4 includes steps as follows.

Step 401, generate a current random number according to the first parameter, and set the highest order bit and lowest order bit of the current random number to be 1 respectively.

Specifically, in the Embodiment 4 of the invention, the highest order bit of the current random number refers to a high order bit of the current random number and setting the highest order bit of the current random number to be 1 ensures enough digits for the current random number and setting the lowest order bit of the current random number to be 1 ensures that the current random number is an odd number.

Preferably, the random number generated in Embodiment 4 of the invention is a number of 1024 bits, for example the current random number is P₁:

P₁=D02C3EC6C4B4BF5AF8519F1EFA08CC97A2798CE7197D22440695126FDA 2F2B6C282515A43E6AB8D7179D085E6F76EFD7150FF21E86C8A88C38BCDC426E4 DB8AB.

Step 402, obtain remainders by respectively dividing all prime numbers in the little prime number table by the current random number and stores the remainders in a temporary array so as to form a remainder array.

Specifically, the current random number is stored in a computer in the form of a word set with word length of 2″ bits. The word set comprises words and includes M words, in which M equals to a result of dividing 2″ by digits of the current random number. Inside the computer a double-world variable T is defined, which includes a high bit TH and a low bit TL.

The obtaining remainders of the current random number includes: obtaining a first remainder by dividing a first prime number in the little prime number table by a first word of the current random number, storing the first remainder in TH, storing a second word of the current random number in TL; obtaining a second remainder by dividing the first prime number in the little prime number table by T, replacing element in TH with the second remainder and replacing element in TL with a third word of the current random number; obtaining a third remainder by dividing the first prime number in the little prime number table by T and replacing element in TH with the third remainder; going on above operations of remainder obtaining, storing and replacing till element in TL is replaced with the Mth word of the current random number, and obtaining a fourth remainder by dividing the first prime number in the little prime number table by T, storing the fourth remainder in the remainder array and obtaining rest remainders by dividing the rest prime numbers in the little prime number table by the current random number with the above method, respectively.

Preferably in the Embodiment 4, the little prime number table includes 53 prime numbers as below:

03, 05, 07, 0B, 0D, 11, 13, 17, 1D, 1F, 25, 29, 2B, 2F, 35, 3B, 3D, 43, 46, 49, 4F, 53, 59, 61, 65, 67, 6B, 6D, 71, 7F, 83, 89, 8B, 95, 97, 9D, A3, A7, AD, B3, B5, BF, C1, C5, C7, D3, DF, E3, E5, E9, EF, F1, FB.

Correspondingly, the elements in the remainder array are

00, O2, 03, 00, 03, 04, 09, O2, 18, 10, 16, 01, 18, 13, 2D, 09, 2D, 09, 11, 2D, 36, 15, 03, 2C, 0C, 4E, 5E, 36, 5B, 7A, 14, 83, 88, 17, 44, 93, 6A, 32, 6C, 7B, 39, 8A, B6, 90, A7, 57, 32, 2D, 03, 29, 40, 40, 4D.

Step 403, determine whether there is 0 in the remainder array, if there is 0, it is determined that the current random number does not pass the sifting of the little prime number table, Step 404 is executed; if there is not 0, it is determined that the current random number passes sifting of the little prime number table, Step 406 is executed.

Step 404, add a first predetermined value to the current random number.

Preferably, the first predetermined value is 2n and specifically in the Embodiment 4, n is a positive integer. If the first predetermined value is 2, the integer 2 is added to the current random number.

Specifically, in the Embodiment 4, if there is 0 in the remainder array obtained by dividing by the current random number P₁, it shows that the current random number P₁ does not pass the sifting of the little prime number table and P₁′ is generated by adding an integer number 2 to the current random number P₁.

P₁′=D02C3EC6C4B4BF5AF8519F1EFA08CC97A2798CE7197D22440695126FDA2 F2B6C282515A43E6AB8D7179D085E6F76EFD7150FF21E86C8A88C38BCDC426E4 DB8AD.

Step 405, add a first predetermined value to each element in the remainder array so as to form corresponding new elements, and subtract a prime number in the little prime number table from one new element which is greater than and identical to the corresponding prime number in the little prime number table and go to Step 403.

Correspondingly, in the Embodiment 4 of the invention, the remainder array is obtained as below after executing Step 405:

02, 04, 05, O2, 05, 06, 0B, 04, 1A, 12, 18, 03, 1A, 15, 2F, 0B, 2F, 0B, 13, 30, 38, 17, 05, 2E, 0E, 51, 61, 38, 5D, 7C, 16, 85, 8A, 19, 46, 95, 6C, 34, 6E, 7D, 3B, 8C, B8, 92, A9, 59, 34, 30, 05, 2B, 42, 42, 4F.

Step 406, check for whether the current random number is a prime number, if yes, go to Step 407; otherwise go to Step 404.

Preferably, in the Embodiment 4, determining whether the current random number is a prime number by primaliry test includes obtaining remainders by dividing the current random number by different random numbers which are smaller than the current random number, to the (p−1)th power, and checking for whether the remainders are 1, if the remainders are 1, it is determined that the current random number is a prime number. For example, the random number is p.

Step 407, output the current random number.

Preferably, in the Embodiment 4, the current random number output is a large prime number selected.

The solution provided by the Embodiment 4 of the invention selects generated random numbers by modulo operation and performing primality test on the random numbers which meet the requirement, and thus reduces times for primality test and further saves time for generating a large prime number. The solution solves a problem of longer time spending on generating a large prime number by too many times of primality test.

### Embodiment 5

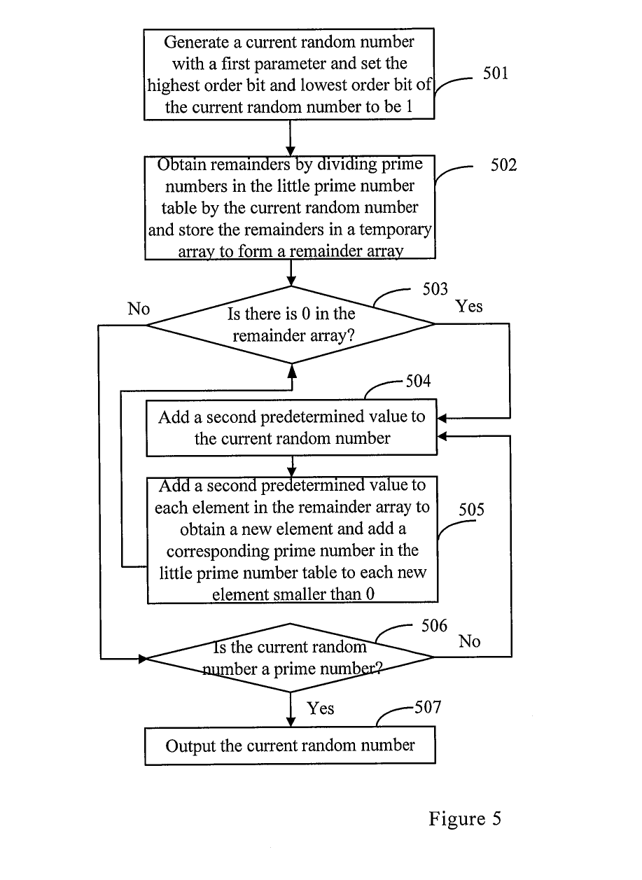

As illustrated in FIG. 5, a flow chart of method for generating a large prime number is provided in Embodiment 5 of the invention, including a solution as below.

Generate a random number with predetermined number of digits according to a first parameter input which is number of digits of the random number. Preferably in Embodiment 5 of the invention, a random number exceeding two bytes is defined as a large number. Perform little prime number sifting on the random number, and then perform primality test on the random number after the above sifting, if the primality test passes, take the random number as a large prime number and output the large prime number. Preferably, the little prime number table in Embodiment 5 of the invention is a set of prime numbers without exceeding 2 bytes and elements in the little prime number table are pre-stored in the computer. Embodiment 5 includes steps as follows.

Step 501, generate a current random number according to a first parameter and set both the highest order bit and lowest order bit of the current random number to be 1.

Specifically, in the Embodiment 5 of the invention, the highest order bit of the current random number refers to a high order bit of the current random number and setting the highest order bit of the current random number to be 1 ensures enough digits for the currently generated random number while setting the lowest order bit of the current random number to be 1 ensures that the currently generated random number is an odd.

Preferably, the current random number generated in the Embodiment 5 of the invention is a number of 512 bits and the current random number is taken as P₂:

P₂=C1F7821A42CC4D35AB46E01A89034E3227B8A7FBA374C170C103585CD4 994499177D267794C183176D044CAF181B4B9E762E3C60C9E0E17AF 1 ABBBD4C79 7AF21.

Step 502, obtain remainders by respectively dividing all prime numbers in the little prime number table by the current random number and store the remainders in a temporary array so as to form a remainder array.

Preferably, in the Embodiment 5 of the invention, the little prime number table includes 45 prime numbers as follows:

001D, 001F, 0025, 0029, 002B, 002F, 0035, 003B, 003D, 0043, 0047, 0049, 004F, 0053, 0059, 0061, 0065, 0067, 006B, 006D, 0071, 007F, 0083, 0089, 008B, 0095, 0097, 009D, 00A3, 00A7, GOAD, 00B3, 00B5, 00BF, 00C1, 0005, 0007, 00D3, 00DF, 00E3, 00E5, 00E9, 00EF, 00F1, 00FB;

Correspondingly, elements in the remainder array include:

0000, 0018, 0018, 0026, 0028, 0024, 0008, 001C, 0007, 0037, 0022, 0006, 0009, 003E, 002F, 004C, 003C, 0064, 0010, 001F, 0046, 0018, 005A, 0077, 0082, 0047, 0025, 002A, 0058, 0021, 0040, 00AE, 0063, 0090, 004C, 0096, 006B, 002F, 000E, 0087, 002F, 0064, 00A9, 00DC, 0023.

Step 503, determine whether there is 0 in the remainder array, if there is 0, it is determined that the current random number does not pass the little prime number table sifting, go to Step 504; if there is not 0, it is determined that the current random number passes the little prime number table sifting, go to Step 506.

Step 504, add a second predetermined value to the current random number.

Preferably, the second predetermined value is 2n and in the Embodiment 5 of the invention, n is a negative integer number. If the second predetermined value is −4, and the current random number is added with the integer number −4.

Specifically, in the Embodiment 5 of the invention, if there is 0 in the remainder array obtained by dividing by the large number P₂, it is determined that the current random number P₂ does not pass the little prime number table sifting and the current random number is added with an integer number −4 to obtain P₂′.

P₂′=C1F7821A42CC4D35AB46E01A89034E3227B8A7FBA374C170C103585CD4 994499177D267794C183176D044CAF181B4B9E762E3C60C9E0E17AF1ABBBD4C79 7AF1D.

Step 505, add the second predetermined value to each element in the remainder array so as to form corresponding new elements, add a corresponding prime number in the little prime number table to those new elements which are smaller than 0 and go to Step 503.

Correspondingly, in the Embodiment 5 of the invention, the remainder array obtained after Step 503 is executed is:

0019, 0014, 0014, 0022, 0024, 0020, 0004, 0018, 0003, 0033, 001E, 0002, 0005, 003A, 002B, 0048, 0038, 0060,000C, 001B, 0042, 0014, 0056, 0073, 007E, 0043, 0021, 0026, 0054, 001D, 003C, 00AA, 005F, 008C, 0048, 0092, 0067, 002B, 000A, 0083, 002B, 0060, 00A5, 00D8, 001F.

Step 506, check for whether the current random number is a prime number, if yes, go to Step 507; otherwise, return to Step 504.

Preferably, in the Embodiment 5 of the invention, checking for whether the current random number is a prime number by primality test includes selecting a different random number smaller than the current random number, determining whether the remainder obtained by dividing the current random number by the different random number to the pth power equals to the remainder obtained by dividing the current random number by the different random number, if yes, it is determined that the current random number is a prime number. For example, p is the random number.

Step 507, output the current random number.

Preferably, in the Embodiment 5 of the invention, the current random number output is the large prime number selected.

The solution provided by the Embodiment 5 of the invention selects generated random numbers by modulo operation and performing primality test on the random numbers which meet the requirement, and thus reduces times for primality test and further saves time for generating a large prime number. The solution solves a problem of longer time spending on generating a large prime number by too many times of primality test.

### Embodiment 6

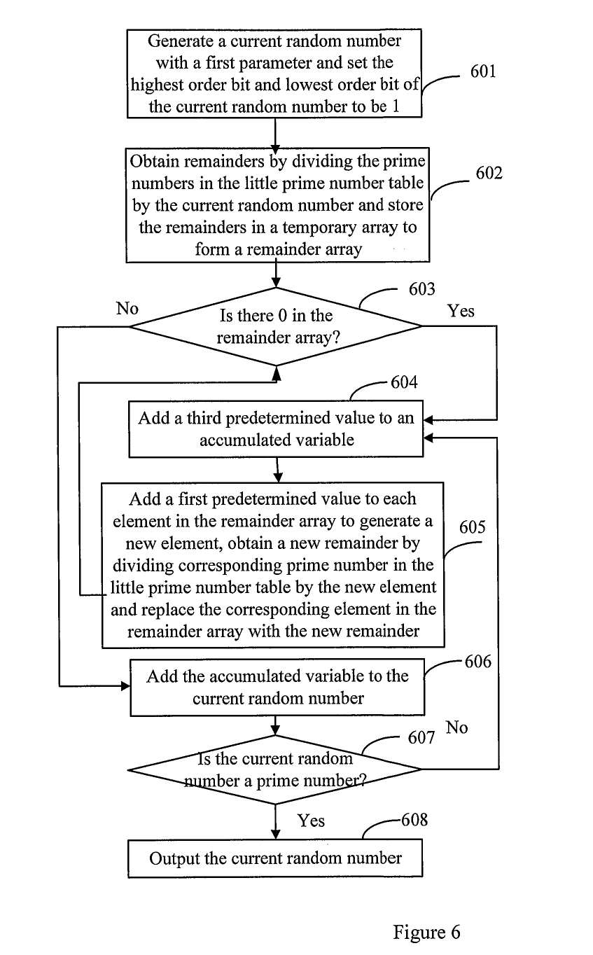

As illustrated in FIG. 6, a flow chart of method for generating a large prime number is provided in Embodiment 6 of the invention, including a solution as below.

Generate a random number with predetermined number of digits according to a first parameter input which is number of digits of the random number. Preferably in Embodiment 6 of the invention, random number exceeding 4 bytes is defined as a large number. Perform little prime number sifting on the random number, and then perform primality test on the random number after the above sifting, if the primality test passes, take the random number as a large prime number and output the large prime number. Preferably, the little prime number table in Embodiment 6 of the invention is a set of prime numbers without exceeding 4 bytes and elements in the little prime number table and an accumulated variable are pre-stored in the computer. Initial value of the accumulated variable is 0. Embodiment 6 includes steps as follows.

Step 601, generate a current random number according to a first parameter and set both the highest order bit and the lowest order bit of the current random number to be 1.

Specifically, in the Embodiment 6 of the invention, the highest order bit of the current random number is the high order bit of the current random number and setting the highest order bit of the current random number to be 1 aims at enough digits of the current random number generated while setting the lowest order bit of the current random number to be 1 aims at guaranteeing that the current random number generated is an odd number.

Preferably, the current random number generated in the Embodiment 6 of the invention is in 256 bits.

Set the current random number to be P₃.

P₃=F99310E590592EE6186A4E0A40AED3883B7967E2CE92B8A7724D8868DFD 5CEF7.

Step 602, obtain remainders by dividing the prime numbers in the little prime number table by the current random number and store the remainders in a temporary array so as to form a remainder array.

Preferably in the Embodiment 6 of the invention, the little prime number table contains 40 prime numbers as below.

0003, 0005, 0007, 000B, 000D, 0011, 0013, 0017, 001D, 001F, 004F, 0053, 0059, 0061, 0065, 0067, 006B, 006D, 0071, 007F, 0083, 0089, 008B, 0095, 0097, 009D, 00A3, 00A7, GOAD, 00B3, 00B5, 00BF, 00C1, 0005, 0007, 00D3, 00DF, 00E3, 00E5, 00E9.

Correspondingly, elements in the remainder array are listed below: 0000, 0000, 0002, 0001, 0006, 000E, 000A, 0004, 0010, 0006, 0035, 0021, 002D, 003F, 0045, 0008, 002D, 0043, 0003, 0055, 0062, 0014, 0039, 0028, 005B, 002C, 009C, 002A, 0080, 007B, 0F3E, 015A, 01D7, 06AF, 037A, 027A, 0344, 08DA, 0796, 0EA7.

Step 603, determine whether there is 0 in the remainder array, if there is 0 in the remainder array, it is determined that the current random number does not pass the little prime number table sifting, go to Step 604; if there is not 0 in the remainder array, it is determined that the current random number passes the little prime number table sifting, go to Step 606.

Step 604, add a third predetermined value to the accumulated variable.

Preferably, the third predetermined value is 2n, in which n is a positive integer number. If the third predetermined value is 4, the current random number is added with the integer number 4.

Specifically, in the Embodiment 6 of the invention, if there is 0 in the remainder array obtained by dividing by a large number P₃, it is determined that the current random number P₃ does not pass the little prime number table sifting and the current random number is added the integer number 4 so as to generate P₃′.

P₃′=F99310E590592EE6186A4E0A40AED3883B7967E2CE92B8A7724D8868DF D5CEF9.

Step 605, add a first predetermined value to each element in the remainder array so as to generate a corresponding new element, obtain a remainder by dividing a prime number corresponding to the new element, in the little prime number table by the new element and replace the corresponding element in the remainder array with the remainder and go to Step 603.

Specifically, in the Embodiment 6 of the invention, the remainder array obtained after executing Step 605 is:

0002, 0002, 0004, 0003, 0008, 0010, 000C, 0006, 0012, 0008, 0037, 0023, 002F, 0041, 0047, 000A, 002F, 0045, 0005, 0057, 0064, 0016, 003B, 002A, 005D, 002E, 009E, 002C, 0082, 007D, 0F40, 015C, 01D9, 06B1, 037C, 027C, 0346, 08DC, 0798, 0EA9.

Step 606, add an accumulated variable to the current random number.

Step 607, check for whether the current random number is a prime number, if the current random number is a prime number, go to Step 608; otherwise, return to Step 604.

Step 608, output the current random number.

Preferably, in the Embodiment 6, the current random number output is the large prime number selected.

The solution provided by the Embodiment 6 of the invention selects generated random numbers by modulo operation and performing primality test on the random numbers which meet the requirement, and thus reduces times for primality test and further saves time for generating a large prime number. The solution solves a problem of longer time spending on generating a large prime number by too many times of primality test.

### Embodiment 7

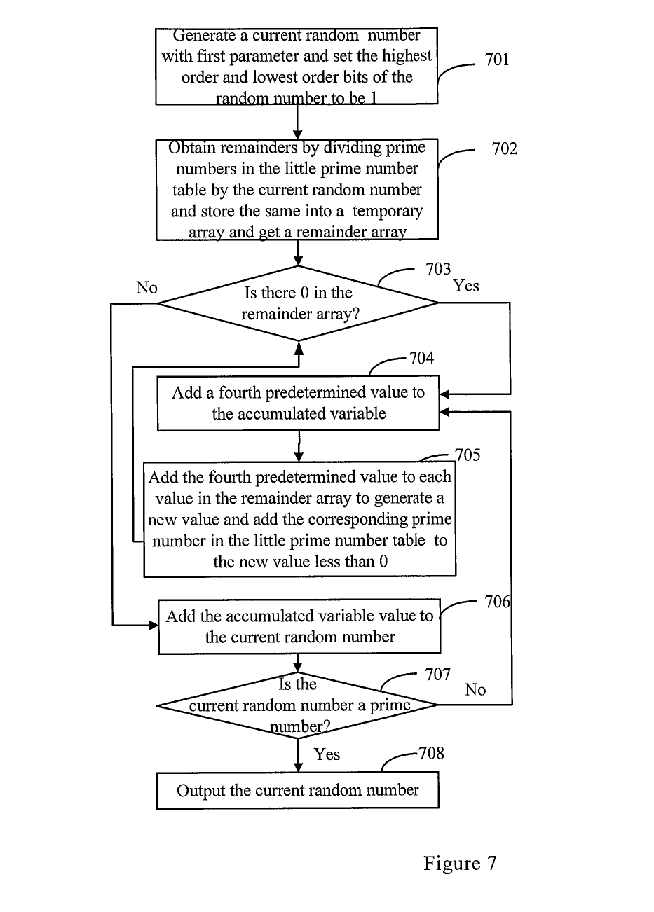

As illustrated in FIG. 7, a flow chart of a method for generating a large prime number is provided in Embodiment 7 of the invention, including a solution as below.

Generate a random number with predetermined number of digits according to a first parameter input which is number of digits of the random number. Preferably, in Embodiment 7 of the invention, a random number exceeding 6 bytes is defined as a large number. Perform little prime number sifting on the random number, and then perform primality test on the random number after the above sifting, if the primality test passes, take the random number as a large prime number and output the large prime number. Preferably, the little prime number table in Embodiment 7 of the invention is a set of prime numbers without exceeding 6 bytes; elements in the little prime number table and an accumulated variable are pre-stored in the computer. Initial value of the accumulated variable is 0. Embodiment 7 includes steps as follows.

Step 701, generate a current random number according to a first parameter and set the highest order bit and lowest order bit of the current random number to be 1.

Specifically, in the Embodiment 7 of the invention, the highest order bit of the current random number is a high order bit of the current random number and setting the highest order bit of the current random number to be 1 ensures enough digits of the current random number generated while setting the lowest order bit of the current random number to be 1 ensures that the current random number generated is an odd number.

Preferably, the current random number generated in the Embodiment 7 of the invention is in 384 bits.

Set the current random number to be P₄.

P₄=F12A47AD213E43868E9909449009BA34DD490CF531015AB47F0ECCEDFC 6126E6C7D6233A49751B8543A4C429C920FDE5.

Step 702, obtain remainders by dividing all prime numbers in the little prime number table by the current random number and stores the remainders in a temporary array so as to form a remainder array.

Preferably, in the Embodiment 7 of the invention, the little prime number table includes 45 prime numbers as below:

0003, 0005, 0007, 000B, 000D, 0011, 0013, 0017, 001D, 001F, 0083, 0089,008B, 0095, 0097, 009D, 00A3, 00A7, GOAD, 00B3, 00B5, 00BF, 00C1, 0005, 0007, 00D3, 00DF, 00E3, 00E5, 00E9, 0167, 016F, 0175, 017B, 017F, 0185, 018D, 0191, 0199, 01A3, 0AC1, 0ACF, 0AD9, 0AE5, 0AE7, 0AED, 0AF1, 0AF3, 0B03, 0B11, 0077, 0083, 0089, 0C91, 0C95.

Correspondingly, the remainder array contains elements as below:

0001, 0000, 0000, 0000, 0001, 0000,000D, 0006, 000C, 0013, 005D, 006C, 0029, 003C, 008C, 0010, 006B, 0046, 003E, 000C, 002D, 0094, 005C, 006D, 0068, 004E, 005E, 0076, 005A, 001C, 0156, 00B2, 00E8, 0057, 0019, 0019, 0138, 0149, 0030, 007B, 04A9, 0875, 01D1, 03E0, 02D2, 03D1, 051F, 02E1, 0805, 09A2, 0452, 0687, 041D, 0212, 00F0.

Step 703, determine whether there is 0 in the remainder array, if there is 0 in the remainder array, it is determined that the current random number does not pass the little prime number table sifting and go to Step 704; otherwise, it is determined that the current random number passes the little prime number table sifting and go to Step 706.

Step 704, add a fourth predetermined value to the accumulated variable.

Preferably, the fourth predetermined value is 2n, in which n is a negative integer number. If the fourth predetermined value is −2, the current random number is added an integer number −2.

Specifically, in the Embodiment 7 of the invention, if there is 0 in the remainder array which is generated by dividing by the current random number P₄, it is determined the current random number P₄ does not pass sifting of the little prime number table and the an integer −2 is added to the current random number P₄ to obtain P₄′.

P₄′=F12A47AD213E43868E9909449009BA34DD490CF531015AB47F0ECCEDFC 6126E6C7D6233A49751B8543A4C429C920FDE3.

Step 705, add a fourth predetermined value to each element in the remainder array to obtain a corresponding new element, and add a corresponding prime number in the little prime number table to the new element which is smaller than 0 and go to Step 703.

Correspondingly in the Embodiment 7 of the invention, the remainder array after executing Step 705 includes:

0002, 0003, 0005, 0009, 000C, 000F, 000B, 0004, 000A, 0011, 005B, 006A, 0027, 003A, 008A, 000E, 0069, 0044, 003C, 000A, 002B, 0092, 005A, 006B, 0066, 004C, 005C, 0074, 0058, 001A, 0154, 00B0, 00E6, 0055, 0017, 0017, 0136, 0147, 002E, 0079, 04A7, 0873, 01CF, 03DE, 02D0, 03CF, 051D, 02DF, 0803, 09A0, 0450, 0685, 041B, 0210, 00EE.

Step 706, add an accumulated variable to the current random number.

Step 707, check for whether the current random number is a prime number, if the current random number is a prime number, go to Step 708; otherwise, return to Step 704.

Step 708, output the current random number.

Preferably, in the Embodiment 7 of the invention, the current random number output is the large prime number selected.

The solution provided by the Embodiment 7 of the invention selects generated random numbers by modulo operation and performing primality test on the random numbers which meet the requirement, and thus reduces times for primality test and further saves time for generating a large prime number. The solution solves a problem of longer time spending on generating a large prime number by too many times of primality test.

### Embodiment 8

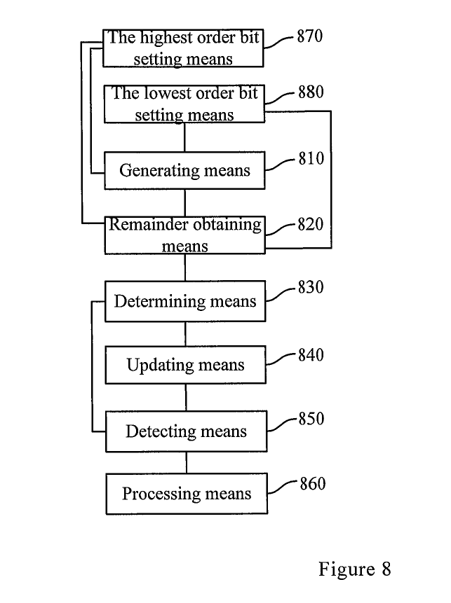

As illustrated in FIG. 8, a structural chart of a device for generating a large prime number is provided in Embodiment 8 of the invention, including a generating means 810, a remainder obtaining means 820, a determining means 830, an updating means 840, a detecting means 850, and a processing means 860.

The generating means 810 is adapted to generate a random number with same digits as the digits input by a user, in which the number of digits of the random number equal to the digits input by the user.

The remainder means 820 is adapted to obtain remainders by dividing all prime numbers in a predetermined little prime number table by a current value of the random number so as to form a remainder array.

The determining means 830 is adapted to determine whether any remainder is 0 in the remainder array.

The updating means 840 is adapted to, if the determining means 830 determines that there is a remainder 0 in the remainder array or if the detecting means detects that current value of the random number is not a prime number, update the random number by a predetermined step, update remainders in the remainder array, and trigger the determining means 830 to determine whether there is a remainder 0 in the remainder array.

Specifically, the above updating means 840 is adapted to update remainders in the remainder array respectively according to the step or update remainders in the remainder array respectively according to the step and prime numbers in the little prime number table.

The above updating means 840 is adapted to update remainders in the remainder array respectively according to the step, if the remainder is smaller than 0 and greater than or equal to a prime number which corresponds to the remainder in the little prime number table, update the remainder according to the prime number.

The updating means 840 can also add the step to the random number and add the step to remainders in the remainder array; or can subtract the step from the random number and subtract the step from remainders in the remainder array.

The updating means 840 is also adapted to add a prime number which corresponds to the remainder in the little prime number table to the remainder in case that the remainder is smaller than 0; or subtract a prime number which corresponds to the remainder in the little prime number table from the remainder in case that the remainder is greater than or equal to the prime number which corresponds to the remainder in the little prime number table; or update the remainder with a remainder result obtained by dividing a prime number which corresponds to the remainder in the little prime number table by the remainder.

The step can be an even number.

The detecting means 850 is adapted to detect whether current value of the random number is a prime number in case that the determining means 830 determines that there is not a remainder 0 in the remainder array.

The processing means 860 is adapted to store or output current value of the random number in case that the detecting means 850 detects that current value of the random number is a prime number.

The device includes

a highest order bit setting means 870 adapted to set the highest order bit of the random number to be 1 in case that the highest order bit of the random number generated by the generating means 810 is not 1, and

a lowest order bit setting means 880 adapted to set the lowest order bit of the random number to be 1 in case that the lowest order bit of the random number generated by the generating means 810 is not 1.

The solution provided by the Embodiment 8 of the invention selects generated random numbers by modulo operation and performing primality test on the random numbers which meet the requirement, and thus times for primality test and further saves time for generating a large prime number. The solution solves a problem of longer time spending on generating a large prime number by too many times of primality test.

### Embodiment 9

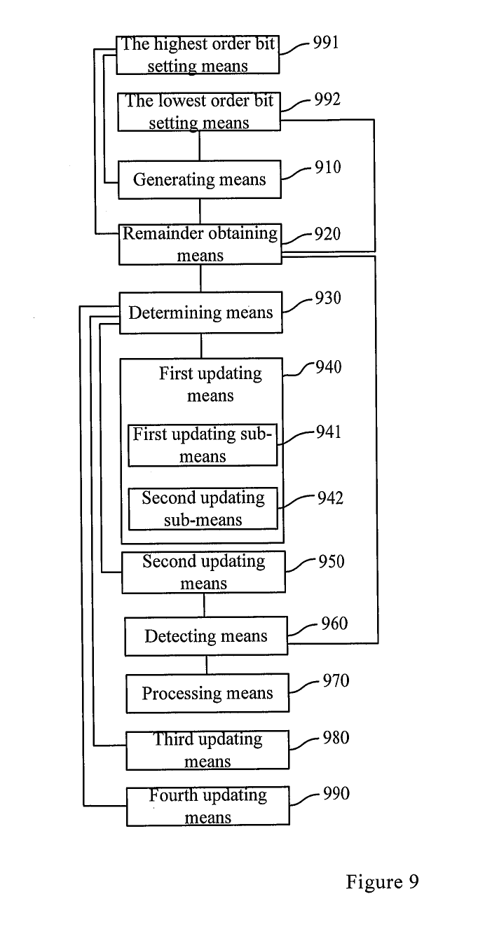

As illustrated in FIG. 9, a structural chart of a device of generating a large prime number is provided in Embodiment 9 of the invention, including a generating means 910, a remainder obtaining means 920, a determining means 930, a first updating means 940, a second updating means 950, a detecting means 960 and a processing means 970.

The generating means 910 is adapted to generate a random number with same digits as the digits input by a user, in which number of digits of the random number is identical to the digits input by the user.

The remainder obtaining means 920 is adapted to obtain remainders by dividing all prime numbers in the predetermined little prime number table by current value of the random number so as to form a remainder array.

The determining means 930 is adapted to determine whether there is a remainder 0 in the remainder array and if the first determining result is positive, trigger the detecting means 960 to detect whether current value of the random number is a prime number.

The first updating means 940 is adapted to, in case that the determining means 930 determines that there is a remainder 0 in the remainder array or the detecting means 960 detects that current value of the random number is not a prime number, update remainders in the remainder array according to a predetermined step and trigger the determining means 930 to determine whether there is a remainder 0 in the remainder array; or update remainders in the remainder array according to the step and prime numbers in the little prime number table and trigger the determining means 930 to determine whether there is a remainder 0 in the remainder array.

Specifically the first updating means 940 includes

a first updating sub-means 941 adapted to update remainders in the remainder array according to the step respectively, and

a second updating sub-means 942 adapted to, in case that a remainder is smaller than 0, greater than or equal to a prime number which corresponds to the remainder in the little prime number table, update the remainder according to the prime number.

Specifically, the second updating sub-means 942 is adapted to, in case that the remainder is smaller than 0, add a prime number which corresponds to the remainder in the little prime number table to the remainder; in case that the remainder is greater than or equal to a prime number which corresponds to the remainder in the little prime number table, subtract the prime number which corresponds to the remainder in the little prime number table from the remainder; or replace the remainder with a remainder obtained by dividing a prime number which corresponds to the remainder in the little prime number table by the remainder.

The second updating means 950 is adapted to update the random number and trigger the detecting means 930 to detect whether current value of the random number is a prime number in case that the first determining result of the determining means 930 is positive.

The detecting means 960 is adapted to detect whether current value of the random number is a prime number.

The processing means 970 is adapted to store or output current value of the random number in case that the detecting means detects that current value of the random number is a prime number.

The device includes

a third updating means 980 adapted to update an intermediate variable according to the step in case that the determining means 930 determines that there is a remainder 0 in the remainder array. Initial value of the intermediate variable is 0.

Correspondingly, the second updating means 950 is adapted to replace the random number with sum of the random number and current value of the intermediate variable.

If the first update sub-means 941 adds the step to remainders in the remainder array respectively, the third updating means 980 is adapted to add the step to the intermediate variable.

If the first updating sub-means 941 subtracts the step from remainders in the remainder array; correspondingly, the third updating means 980 is adapted to subtract the step from the intermediate variable.

The device further includes a fourth updating means 990 adapted to, if the determining means 930 determines that there is a remainder 0 in the remainder array, add 1 to the updating times. Initial value of the updating times is 0. Correspondingly, the second updating means 950 is adapted to update the random number according to the updating times and the step.

If the first updating sub-means 941 adds the step to remainders in the remainder array respectively, the second updating means 950 is adapted to add product of the updating times and the step to the random number.

If the first updating sub-means 941 subtracts the step from remainders in the remainder array respectively, the second updating means 950 is adapted to subtract the product of the updating times and the step from the random number.

The step can be an even number.

The device further includes

a highest order bit setting means 991 which is adapted to set the highest order bit of the random number to be 1 in case that the highest order bit of the random number generated by the generating means 910 is not 1, and

a lowest order bit setting means 992 which is adapted to set the lowest order bit of the random number to be 1 in case that the lowest order bit of the random number generated by the generating means 910 is not 1.

The solution provided by the Embodiment 9 of the invention selects generated random numbers by modulo operation and performing primality test on the random numbers which meet the requirement, and thus reduces times for primality test and further saves time for generating a large prime number. The solution solves a problem of longer time spending on generating a large prime number by too many times of primality test.

The method for generating a large prime number and the device thereof provided by the Embodiment 9 of the invention can be used in an embedded system.

Steps for executing the method or algorithm described in the embodiments of the invention can be implemented by a hardware or a software modules processed by a processor or a combination of them. The software modules can be installed in a random access memory, a register, a hard disk, a portable disk, a CD-ROM or other form of storage medium well known in the prior art.

The above mentioned are just preferred embodiments of the invention, not a limit to the scope of protection of the invention, and any obvious change or substitution for those skilled in the art within the scope of technology disclosed by the invention should be covered by the scope of protection of the invention, and therefore, the scope of protection of the invention should be based on the scope of protection of the claims appended.

1. A method for generating a large prime number, characterized in that said method comprises
Step 1, generating a random number in size corresponding to number of digits input by a user, in which the number of digits of the random number is identical to the number of digits input by the user;
Step 2, obtaining remainders by dividing all prime numbers in a predetermined little prime number table by a current value of the random number respectively, so as to form a remainder array;
Step 3, determining whether any remainder is 0 in the remainder array, if yes, going to Step 4; otherwise going to Step 5;
Step 4, updating the random number according to a predetermined step size, updating all remainders in the remainder array, and returning to Step 3;
Step 5, checking for whether the current value of the random number is a prime number, if yes, going to Step 6; otherwise, going to Step 4; and
Step 6, storing or outputting the current value of the random number.

2. The method of claim 1, wherein the updating all remainders in the remainder array comprises
updating remainders in the remainder array with the predetermined step size; or
updating remainders in the remainder array with the predetermined step size and the prime numbers in the little prime number table.

3. The method of claim 2, wherein the updating remainders in the remainder array with the predetermined step size and the prime numbers in the little prime number table comprises
updating the remainders in the remainder array with the predetermined step size;
if the remainder is smaller than 0, greater than or identical to a prime number corresponding to the remainder in the little prime number table, updating the remainder with the prime number.

4. The method of claim 3, wherein the updating the random number with a predetermined step size comprises
adding the step size to the random number itself; and
the updating remainders in the remainder array with the predetermined step size comprises
adding the step size to all remainders in the remainder array one by one.

5. The method of claim 3, wherein the updating the random number with a predetermined step size comprises
subtracting the step size from the random number; and
the updating remainders in the remainder array with the predetermined step size comprises
subtracting the step size from remainders of the remainder array one by one.

6. The method of claim 3, wherein, if the remainder is smaller than 0, greater than or identical to a prime number corresponding to the remainder in the little prime number table, updating the remainder with the prime number comprises,
if the remainder is smaller than 0, adding a prime number in the little prime number table which corresponds to the remainder to the remainder;
if the remainder is greater than or identical to a prime number in the little prime number table which corresponds to the remainder, subtracting the remainder from the prime number in the little prime number table which corresponds to the remainder; or updating the remainder as a remainder result obtained by dividing the prime number in the little prime number table which corresponds to the remainder by the remainder.

7. The method of claim 1, wherein the step size is an even number.

8. The method of claim 1, wherein after generating a random number in size corresponding to digits input by a user, the method further comprises,
if the highest order bit of the random number is not 1, setting the highest order bit to be 1.

9. The method of claim 1, wherein, after generating a random number in size corresponding to digits input by a user, the method further comprises,
if the lowest order bit of the random number is not 1, setting the lowest order bit to be 1.

10. A method for generating a large prime number, characterized in that said method comprises
Step 1, generating a random number in size corresponding to a number of digits input by a user, in which number of digits of the random number is identical to the number of digits input by the user;
Step 2, obtaining remainders by dividing prime numbers in a predetermined little prime number table by a current value of the random number, so as to form a remainder array;
Step 3, determining whether any remainder is 0 in the remainder array, if yes, going to Step 4; otherwise, going to Step 7;
Step 4, updating remainders in the remainder array with a predetermined step size one by one; or updating remainders in the remainder array with the step size and prime numbers in the little prime number table one by one;
Step 5, determining whether any remainder is 0 in the remainder array, if yes, going to Step 4; otherwise, going Step 6;
Step 6, updating the random number;
Step 7, checking for whether the current value of the random number is a prime number, if yes, going to Step 8, otherwise, going to Step 4; and
Step 8, storing or outputting the current value of the random number.

11. The method of claim 10, wherein the updating remainders in the remainder array with the step size and prime numbers in the little prime number table one by one comprises
updating remainders in the remainder array with the step size one by one; and
if the remainder is smaller than 0, greater than or identical to the prime number in the little prime number table which corresponds to the remainder, updating the remainder with the prime number.

12. The method of claim 11, wherein if the remainder is smaller than 0, greater than or identical to a prime number in the little prime number table which corresponds to the remainder, updating the remainder with the prime number comprises
if the remainder is smaller than 0, adding the prime number in the little prime number table which corresponds to the remainder, to the remainder; and
if the remainder is greater than or identical to the prime number in the little prime number table which corresponds to the remainder, subtracting the prime number in the little prime number table which corresponds to the remainder from the remainder; or updating the remainder as a result obtained by dividing the prime number in the little prime number table which corresponds to the remainder by the remainder.

13. The method of claim 11, wherein, after determining whether any remainder is 0 in the remainder array, the method comprises
updating an intermediate variable with the step size, of which an initial value of the intermediate variable is 0; and
the updating the random number comprises
updating the random number with sum of the random number and a current value of the intermediate variable.

14. The method of claim 13, wherein
the updating remainders in the remainder array with the step size one by one comprises
adding the step size to the remainders in the remainder array one by one; and
the updating the intermediate variable with the step size comprises
adding the step size to the intermediate variable.

15. The method of claim 13, wherein
the updating remainders in the remainder array with the step size one by one comprises
subtracting the step size from the remainders in the remainder array one by one; and
the updating the intermediate variable with the step size comprises
subtracting the step size from the intermediate variable.

16. The method of claim 11, wherein after determining whether any remainder is 0 in the remainder array, the method further comprises
adding 1 to updating times, of which an initial value of the updating times is 0; and
the updating the random number comprises
updating the random number with the updating times and the step size.

17. The method of claim 16, wherein
the updating remainders in the remainder array with the step size one by one comprises
adding the step size to each remainder in the remainder array; and
the updating the random number with the updating times and the step size comprises
adding a product of the updating times and the step size to the random number.

18. The method of claim 16, wherein
the updating remainders in the remainder array with the step size one by one comprises
subtracting the step size from the remainders in the remainder array one by one; and
the updating the random number with the updating times and the step size comprises
subtracting a product of the updating times and the step size from the random number.

19. The method of claim 10, wherein the step is an even number.

20. The method of claim 10, wherein after generating a random number in size corresponding to number of digits input by a user, the method further comprises,
if the highest order bit of the random number is not 1, setting the highest order bit of the random number to be 1; and
if the lowest order bit of the random number is not 1, setting the lowest order bit of the random number to be 1.
